(19) United States
(12) Patent Application Publication
(10) Pub. No.: US 2008/0059986 A1
(43) Pub. Date: Mar. 6, 2008

(54) Online video/chat applications

(76) Inventors: Brian Kalinowski, North Grafton, MA (US); Donald Michael Kosak, Marlborough, MA (US)

Correspondence Address: FISH & RICHARDSON PC, P.O. BOX 1022, MINNEAPOLIS, MN, 55440-1022, US

(21) Appl. No.: 11/512,712

(22) Filed: Aug. 30, 2006

(51) Int. Cl. H04N 7/16; G06F 13/00; H04N 7/173; H04N 5/445; G06F 3/00

(52) U.S. Cl. 725/1; 725/25; 725/5; 725/112; 725/113; 725/37; 725/42

(57) ABSTRACT

Presenting video over one or more computer networks includes obtaining permission to distribute video from an owner of rights in the video, charging a flat fee for presentation of the video, where the flat fee being is on a maximum number of users who are permitted to view the video, and following payment of the fee, making the video available to the maximum number of users over the one or more computer networks.

### TECHNICAL FIELD

This patent application relates generally to a system for presenting chat and associated video over one or more computer networks, such as the Internet.

### BACKGROUND

Online chat systems, such as those used by America Online® and MSN®, have been used for years to allow people to communicate, in real-time, over a network, such as the Internet. The chat may be audio, video or textual. For example, a user at one computer writes a message in a chat window to one or more other users. The message is routed over a network to one or more central servers maintained by the owner of the system and, from there, to its intended recipient(s). The recipient(s) may then respond in kind.

It is also well-known to transmit video over a network connection. Various methods may be used for transmission. For example, an entire video clip may be downloaded to a client and, thereafter, played at the client. Alternatively, the video may be streamed to the client. Streaming involves downloading the video, buffering the video at the client, and playing the video substantially in real-time, i.e., about as it is being downloaded. Progressive downloading is another type of video transmission similar to downloading, except that video playback may begin after only a small percentage of the file has been downloaded.

Chat and video are also available through interactive television, such as G4® (www.g4tv.com), which presents interactive episodes of Star Trek® TOS (The Original Series). In the G4®0 system, for example, an episode of Star Trek® is displayed, during which users may enter comments in a chat area. Additional interactive features, such as trivia, are also provided during the presentation.

### SUMMARY

This patent application describes methods and apparatus, including computer program products, for presenting chat and associated video over one or more computer networks, such as the Internet.

In general, in one aspect, this application describes a method performed by a processing system that is capable of communicating to clients over one or more computer networks. The method comprises hosting chat among the clients, providing video to the clients that is associated with the chat, and generating a display that includes an area for the video and an area for the chat. The display comprises information identifying users at the clients who are participating in the chat and viewing the video. This aspect may also include one or more of the following features.

The method may include generating a user interface (e.g., Web page) permitting selection of the video, receiving an indication that the video has been selected, and providing the video in response to the indication. The user interface may comprise an interface containing multiple video presentations from which to select, such that the video is selectable from among the multiple video presentations. The interface may display information associated with at least some of the multiple video presentations. The information may relate to accessibility of the video presentation.

The method may comprise limiting access to the video and associated chat. Limiting access, in this context, may comprise limiting access to users who meet one or more predefined criteria. For example, access may be limited to users who have been invited to participate in the chat and video presentation. In this regard, invitations may be sent to clients who are invited to participate in the chat and video presentation. The invitations may be sent via e-mail (electronic mail), instant message, and/or chat.

Feedback on the video may be requested from participants in the chat. A role of moderator may be assigned to a client (or a user participating in the video/chat at the client). The moderator may be able to filter the chat and thereby allow selective response(s) to the chat. The video may be controlled so that the video is presented substantially synchronously at the clients. Avatars may be generated for the users. The avatars may be controlled to interact with one or more areas of the display for the video.

In general, in another aspect, this application describes a method performed by a processing system that is capable of communicating to clients over one or more computer networks. The method comprises providing the clients with access to video and chat, and synchronizing presentation of the video on at least some of the clients. This aspect may also include one or more of the following features.

Synchronizing presentation of the video may include receiving an indication from at least one of the clients regarding the video, and affecting presentation of the video on the multiple clients in response to the indication. The indication may be generated by the client (e.g., hardware) without input from a user at the client, or the indication may be user-generated and sent via the client. Affecting presentation of the video on the multiple clients may include pausing the video, rewinding the video, fast-forwarding the video, and/or skipping between frames of the video. Providing the clients with access to video may include downloading at least a portion of the video to the clients prior to presentation.

Synchronizing presentation of the video on at least some of the clients may include confirming download of an amount of video (e.g., the entire video or a portion thereof) to the clients prior to presentation, and instructing the clients to begin presentation of the video after confirming. Providing the clients with access to video may include streaming the video to the clients. The method may also include confirming that clients can sustain a predefined transfer rate for streaming the video. The video may be streamed at a predefined quality only to clients that can handle the predefined transfer rate. The video may be streamed at a quality that is less than the predefined quality to clients that cannot handle the predefined transfer rate. For example, only keyframes (or some degraded form) of the video may be provided to clients that cannot handle the predefined transfer rate.

In general, in another aspect, this application describes a method for use in presenting video over one or more computer networks. The method comprises obtaining permission to distribute video from an owner of rights in the video, charging a flat fee for presentation of the video, where the flat fee is based on a maximum number of users who are permitted to view the video, and following payment of the fee, making the video available to the maximum number of users over the one or more computer networks. This aspect may include one or more of the following features.

The flat fee may be based on a quality of the video, with higher-quality video demanding a larger flat fee and lower-quality video demanding a lower flat fee.

The method may include presenting different fee options, where each of the fee options is based on a maximum number of users who are permitted to view the video, and receiving a selection corresponding to one of the fee options. The flat fee may correspond to a fee associated with a selected one of the fee options. Making the video available to the maximum number of users may include requesting users who are not registered to provide registration information, and allowing the users to access the video after receipt of the registration information. The method may include providing an interface (e.g., a Web page) on which the users can enter the registration information.

Charging the flat fee for presentation of the video may include requesting payment of the flat fee from one of the users, where the one of the users is a host user, and receiving an indication that the flat fee has been paid. A virtual tip jar may be generated for accepting payment from users other than the host user. The payment may, or may not, exceed the flat fee. The host user may collect the payment from the virtual tip jar.

The maximum number of users who are permitted to view the video may comprise members of a focus group. The video may be provided to the members of the focus group, and information may be solicited from the members of the focus group regarding the video.

The maximum number of users who are permitted to view the video may comprise users who have been designated to preview the video. The video may be provided to the users who have been designated to preview the video, and information regarding the video may be solicited from the users who have been designated to preview the video.

In general, in another aspect, this application describes a method of offering video for online viewing. This method includes offering the video at a first fee for a first number of users, offering the video for a second fee for a second number of users, where the second fee is different than the first fee, receiving an indication of payment of the first fee or the second fee, and making the video available online to a number of users based on the payment. This aspect may include one or more of the following features.

Making the video available online to a number of users may include requesting users who are not registered to provide registration information, and allowing such users to access the video after receipt of the registration information. The method may include providing an interface on which the users who are not registered can enter the registration information. Payment may be received from a host user who initiates making the video available. A virtual tip jar may be generated for accepting payment from users other than the host user. The payment may, or may not, exceed a predefined amount. The host user may be allowed to collect the payment from the virtual tip jar.

The first or second number of users may comprise members of a focus group. The video may be provided to the members of the focus group. Information may be solicited from the members of the focus group regarding the video.

The first or second number of users may comprise users who have been designated to preview the video. The video may be provided to the users who have been designated to preview the video. Information regarding the video may be solicited from the users who have been designated to preview the video.

This application also describes apparatuses and computer program products for performing the methods summarized above, where the computer program products may be implemented using one or more machine-readable media that store(s) instructions that are executable by one or more processing devices (e.g., microprocessor(s)).

The details of one or more examples are set forth in the accompanying drawings and the description below. Further features, aspects, and advantages of the video/chat system summarized above are apparent in the description, the drawings, and the claims.

### DESCRIPTION OF THE DRAWINGS

FIG. 1 is a block diagram of a computer network and hardware on which the video/chat system described herein may be implemented.

FIG. 2 is a flowchart showing operation of the video/chat system.

FIG. 3 is a block diagram of a Web page that enables a user to access open and invitation-only video/chat sessions.

FIG. 4 is a block diagram of a Web page showing movies that may be selected for presentation during a video/chat session.

FIG. 5 is a block diagram of a Web page showing information that a user may enter following selection of a video and relating to presentation of the video.

FIG. 6 is a block diagram of a Web page showing available video/chat sessions.

FIG. 7 is an example of a Web page for implementing video/chat dating.

FIG. 8 is an example of a Web page showing a user profile.

FIG. 9 is an example of a Web page showing video/chat with a movie director.

FIG. 10 is an example of a Web page showing video/chat regarding a television show in connection with focus group testing.

FIG. 11 is a block diagram of a server interacting with clients in order to synchronize presentation of video on the clients.

FIG. 12 is an example of a Web page showing video/chat with a movie star.

FIG. 13 is an example of a questionnaire provided during focus group testing.

FIG. 14 is a flowchart showing a business method for charging for the video/chat sessions described herein.

Like reference numerals in different figures indicate like elements.

### DETAILED DESCRIPTION

The video/chat system described herein may be implemented in a number of different ways. In one implementation, clients receive video over a computer network, such as the Internet. Users at the clients view the video while participating in online chat. The video may be synchronized among the clients, e.g., frames of the video play may be played at each client at substantially the same time. Synchronization of the video at the clients allows users at the clients to participate in chat concerning the video. For example, synchronization allows users to discuss the content of the video while it is playing. The video/chat system has numerous social and economic applications, as described below.

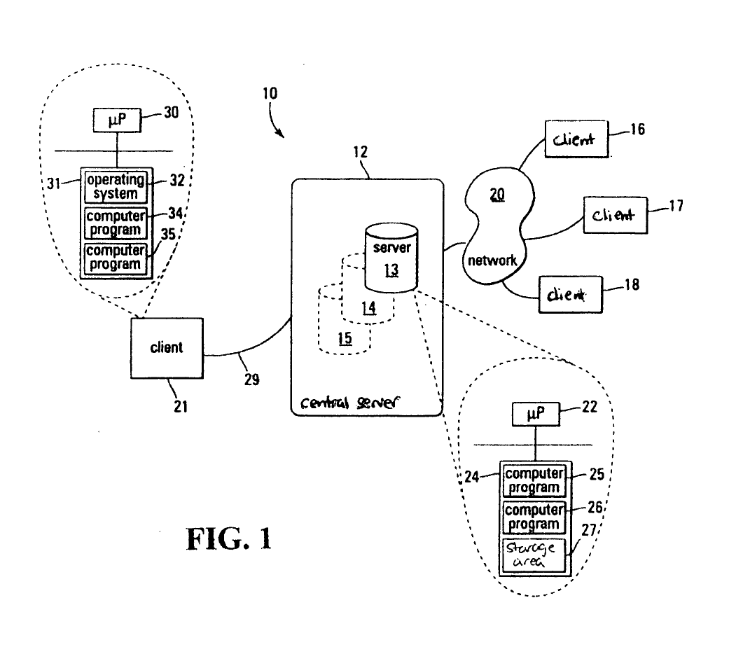

FIG. 1 shows an example of a computer system 10, on which the video/chat system described herein may be implemented. Referring to FIG. 1, computer system 10 includes a central server 12. Central server 12 may include one server 13 or multiple servers 13 to 15 (servers 14 and 15 are depicted using dashed lines to indicate that they are optional). In the case of multiple servers, server 13 may act as a controller or “load balancer” for the remaining servers 14 and 15. In this role, server 13 may route data, requests, and instructions between an “external device” (e.g., a client 16) and a “slave” server, such as server 14. For example, server 13 may handle requests locally until it reaches capacity, then route the requests to a server, such as server 14. In this description, internal communications between server 13 and the slave servers will not be explained in detail.

Server 13 may be any type of processing device that is capable of receiving and storing data, and of communicating with its clients. As shown in FIG. 1, server 13 includes one or more processor(s) 22 and memory 24 that stores computer programs that are executable by processor(s) 22. In this regard, memory 24 stores a computer program 25 for communicating with clients, e.g., to receive, and respond to, requests from clients 16, 17, 18, and/or 21. Memory 24 also contains one or more computer program(s) 26 for implementing the video/chat system described herein. For example, one or more routines may be dedicated to hosting chat, one or more routines may be dedicated to hosting video, and one or more routines may be dedicated to integrating the two. Server 13 may also contain a storage area 27 for storing video that is accessible to clients via the video/chat system. Alternatively, the video may be obtained from external source(s). For example, the video may be obtained from other server(s) over a network connection (the other server(s) may, or may not, be owned by the proprietor of the video/chat system)

Client 21 may include any type of processing device that is capable of communicating with server 12, e.g., over a network. A high-speed data link 29, such as Ethernet, may connect client 21 to server 12. The connection may be local or remote. That is, client 21 may also access server 12 via network 20.

As shown in FIG. 1, client 21 includes one or more processor(s) 30 and memory 31 that stores computer programs that are executed by processor(s) 30. In this regard, memory 31 stores an operating system 32, a computer program 34 that enables communication between client 21 and server 12, and one or more computer programs 35 for use in implementing the client side of the video/chat system. Each client 16 to 18 may have a hardware/software configuration that is the same as, or different than, client 21.

In this regard, clients 16 to 18 and 21 may be computers or any other data processing apparatus including, but not limited to, desktop or laptop computers, personal digital assistants (“PDAs”), mobile telephones, and/or gaming devices. Network 20 provides a communication link between server 12 and clients 16 to 18. Network 20 may include, but is not limited to, a local area network (“LAN”), a wide area network (“WAN”), the Internet, and/or a wireless link (e.g., a wireless fidelity, or “Wi-Fi”, link).

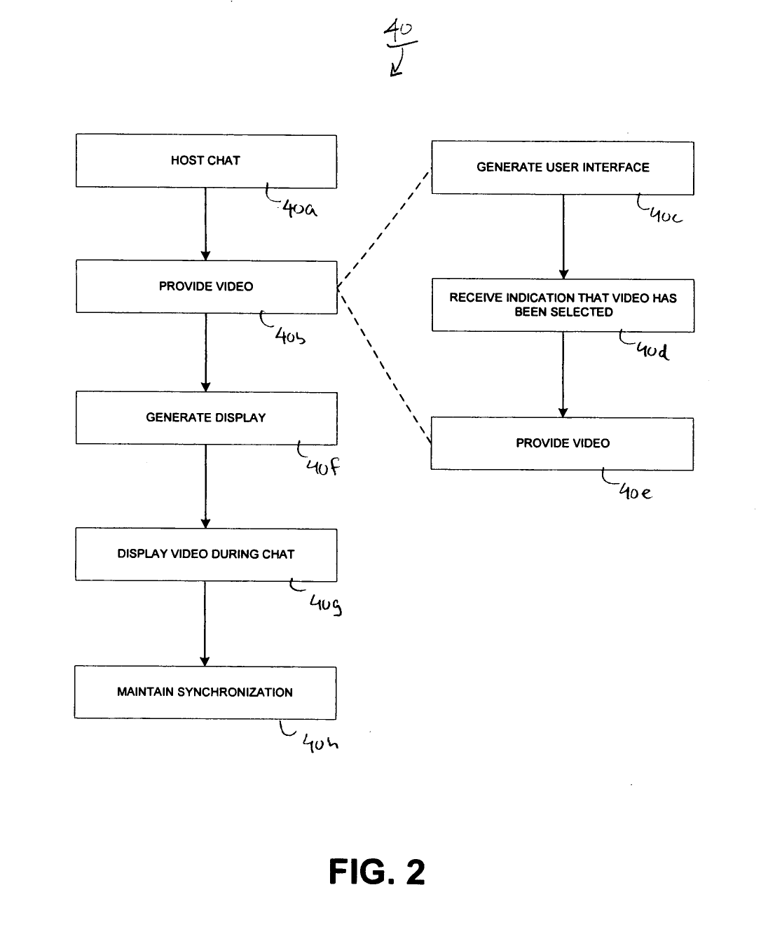

Referring to FIG. 2, a process 40 is shown for implementing the video/chat system described herein. Process 40 may be implemented through computer program(s) 26 running in server 12 in conjunction with computer programs running on a client. A description of process 40 is set forth below, followed by implementations thereof.

According to process 40, server 12 hosts (40a) a chat session among users. Server 12 provides (40b) video to one or more of clients 16 to 18 and 21 that is associated with the chat. To this end, server 12 generates (40c) a user interface (UI) permitting selection of the video, receives (40d) an indication that video has been selected, and (40e) provides video in response to the indication. As explained below, the beginning of the video presentation is synchronized, to the extent possible, among the clients. Server 12 generates (40f) generates a display that includes an area for the video and an area for the chat. As explained below, the display includes information identifying users at the clients who are participating in the chat and viewing the video. Server 12 provides (40g) the video for display in the display area during chat. Server 12 also synchronizes (40h) the video during display. A more detailed explanation of the various actions of process 40 is provided in the following.

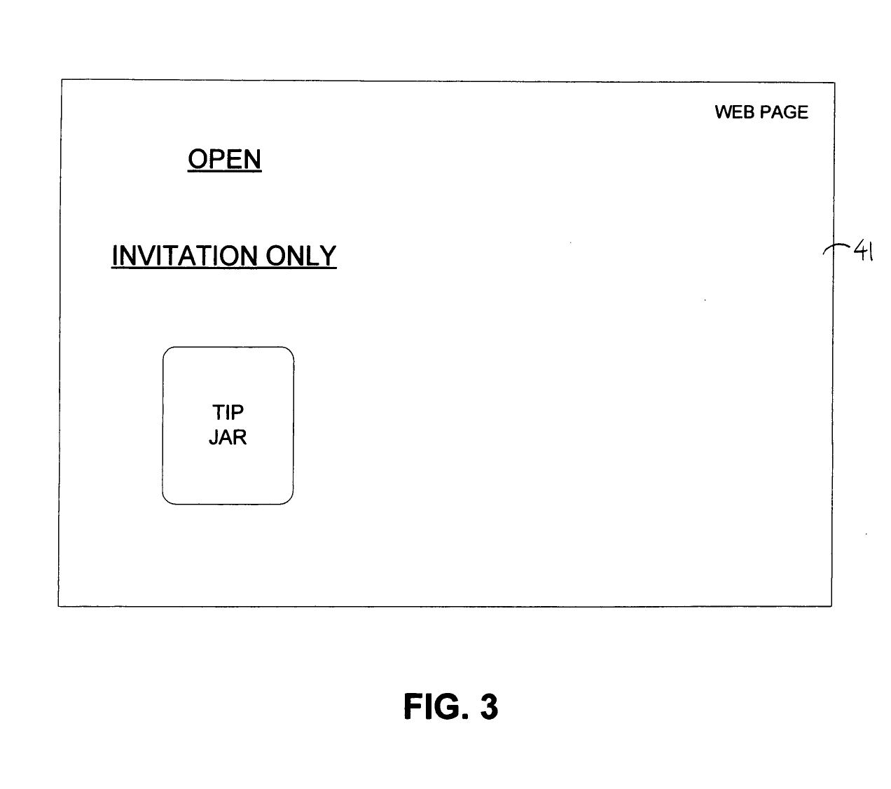

To begin, a client (e.g., 16) initiates a video/chat session. In this implementation, the chat may be via text, voice and/or video. There are a number of ways that a session can be initiated. For example, a user can access a Web page 41 (FIG. 3) that identifies a type of the video/chat session. The video/chat session may be an open session, meaning that anyone who can access server 12 can participate, or it may be an invitation-only session, meaning that it may be limited to users who are invited to participate by the user initiating the session (the initiator). A session is typically limited to a predefined number of people, which may be specified by the initiator. Pricing per video may be based on the number of people participating, as described below. The session may also be limited to users who meet specified criteria. For example, the initiator may limit the participants to females within a particular age group and having particular physical characteristics. Process 40 may screen users who do not meet the specified criteria using profiles that users who participate in the system may be required to fill-out, or using registration information that users who participate in the system may be required to provide.

In this regard, in order to have access to the video/chat system, a user may be required to register with server 12. For example, the user may be required to provide demographic information, such as age, sex, weight, location, etc. This information may be provided via a Web page (not shown) or other registration mechanism. Users may also be required to agree to terms of service, such as not displaying copyrighted material without a license or not displaying pornographic materials via the video/chat system. Server 12 may assign a registered user a user identifier (ID), and associate the information that the user provided with the user ID. The user may assign a password, which is stored on server 12, and which may enable the user, along with the user ID, to access the video/chat system. As part of the system, a user may fill-out a profile containing, e.g., similar demographic information to that which was provided during registration along with, e.g., video preferences, likes, dislikes, user pictures, or the like. The profile may be stored as one or more files maintained by server 12 or it may be a Web page hosted by server 12 or other hardware.

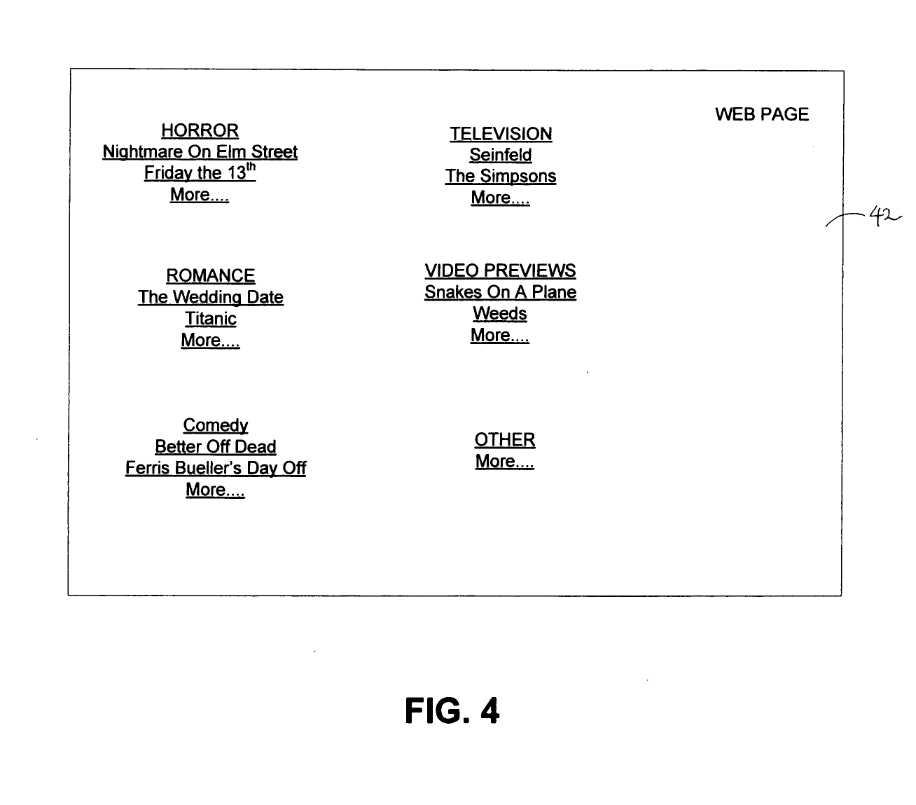

The client selects a movie to present. For example, a user at a client can access a Web page, such as Web page 42 (FIG. 4), containing a list of video (e.g., full-length movies, television shows, online video clips). Web page 42 may, or may not, be hosted by server 12. The user may select a video, e.g., by pointing and clicking on a hyperlink identifying the video. The video may be stored on server 12 or in another location that is accessible to server 12. For example, the video may be part of a video library maintained by a third party, for which the proprietor of the video/chat system has access and a license. Such video likewise may be stored on server 12 or in memory that is local to server 12. The user may browse through a list of video genres when selecting the video. For example, a Web page may list several genres of video (e.g., horror, romance, etc.), and allow the user to navigate, e.g., through hyperlinks, from a genre to a specific movie.

In this regard, a Web page containing available video may be broken-down into themed lobbies. For example, there may be a link to, or section containing, science fiction video, another for romance video, another for action video, and the like. The user may select a video from a section or from elsewhere and play the video, as described below.

The video may be ad-supported video, meaning that it may contain commercials. The video may be obtained from a user and uploaded to server 12. For example, the video may be user-generated video or video that is uploaded, e.g., from a DVD in the user's computer. The charge for using the video/chat system may be based on the video that is presented and/or the number of people who have access to the video online.

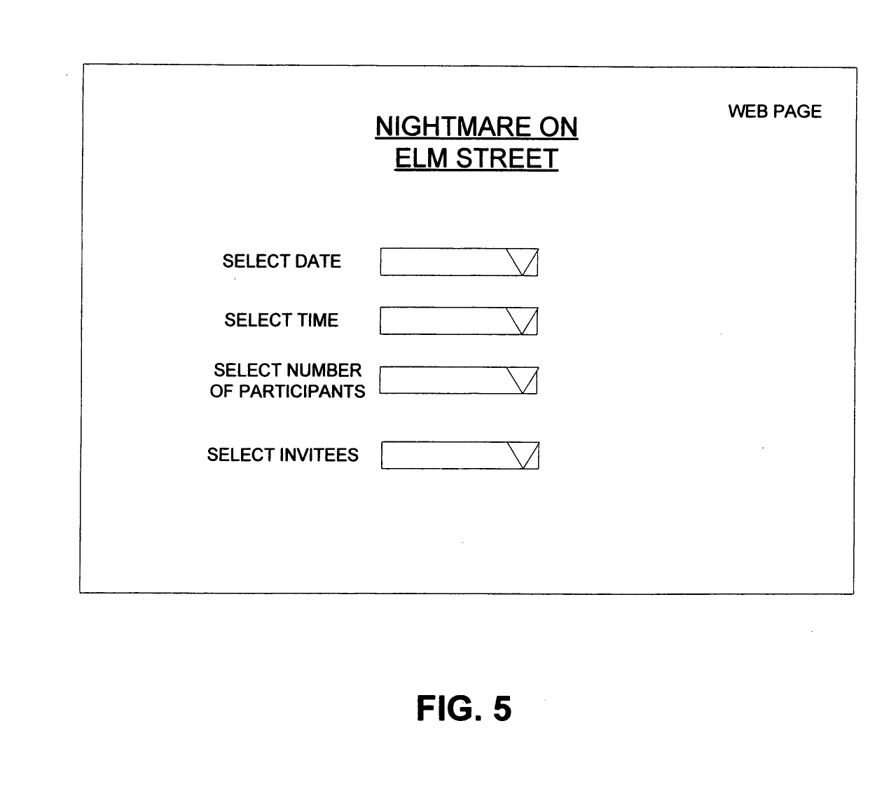

The initiator selects when the video is to be presented. For example, the initiator may select a time and/or date when the video is to be presented, along with a number of participants who may view the video. This information may be provided on Web page 43 (FIG. 5). Alternatively, this information may be provided via another type of online form or through multiple linked or unlinked Web pages. This information is transmitted to server 12, which may then schedule the movie accordingly. If the movie is invitation-only, server 12 may send out invitations to users who are invited to view the movie. For example, server 12 may send out the invitations via electronic mail (e-mail) to the invitees. The e-mail addresses may be provided by the initiator directly or may be identified via a buddy list (not shown) maintained by the initiator with server 12. For example, when prompted for who to invite, the user may select one or more members of their buddy list (e.g., by pointing and clicking on a buddy icon). This identifies the invitee to server 12, which then knows, based on stored information, where to send the invitation. Invitations may also be sent via instant message (IM) by the server or initiator.

Some who are invited to participate in video/chat may not already be registered with the system. In this case, the initiator may provide contact information (e.g., an e-mail address) of such people. Server 12 may use this information to send those people an e-mail containing a hyperlink instructing them to register with the system. The hyperlink may direct the new user to a registration Web page (not shown), which may contain fields required for the new user to fill-in in order to obtain a registration. After registration, the new user may have access to the video/chat in which they were invited to participate. In other implementations, registration may not be necessary for participation.

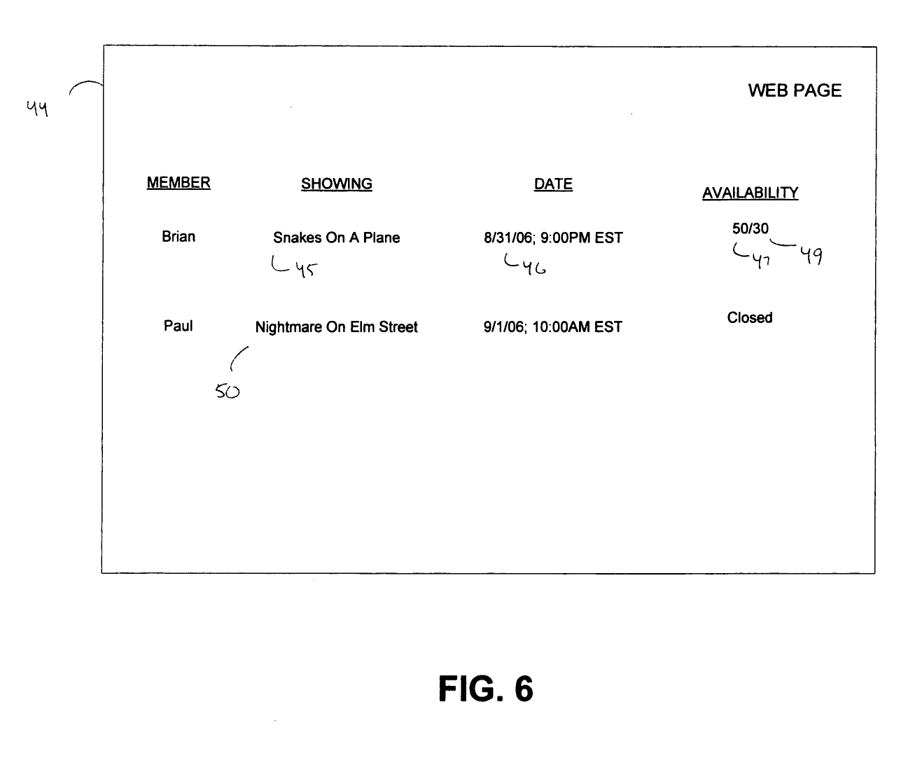

If a video/chat session is designated as open, server 12 may generate a Web page 44 (FIG. 6), which may be viewed by anyone with access to server 12 (e.g., over the Internet). Web page 44 may list a video presentation 45, the date and time 46 it is being presented, the number 47 of people who may view the video, and whether there is any availability 49 left for viewing (e.g., if the total number of viewers may be 50, whether the number of scheduled viewers exceeds 50). Web page 44 may also list closed video session(s) 50 as well, e.g., invitation-only sessions, with a corresponding indicator that the session is not available to the public (non-invitees).

A user may access an available (i.e., open) video/chat session by pointing and clicking on an open session on Web page 44. If the user is not registered, the user may, or may not, be prompted to register in order to participate in the session, as described above.

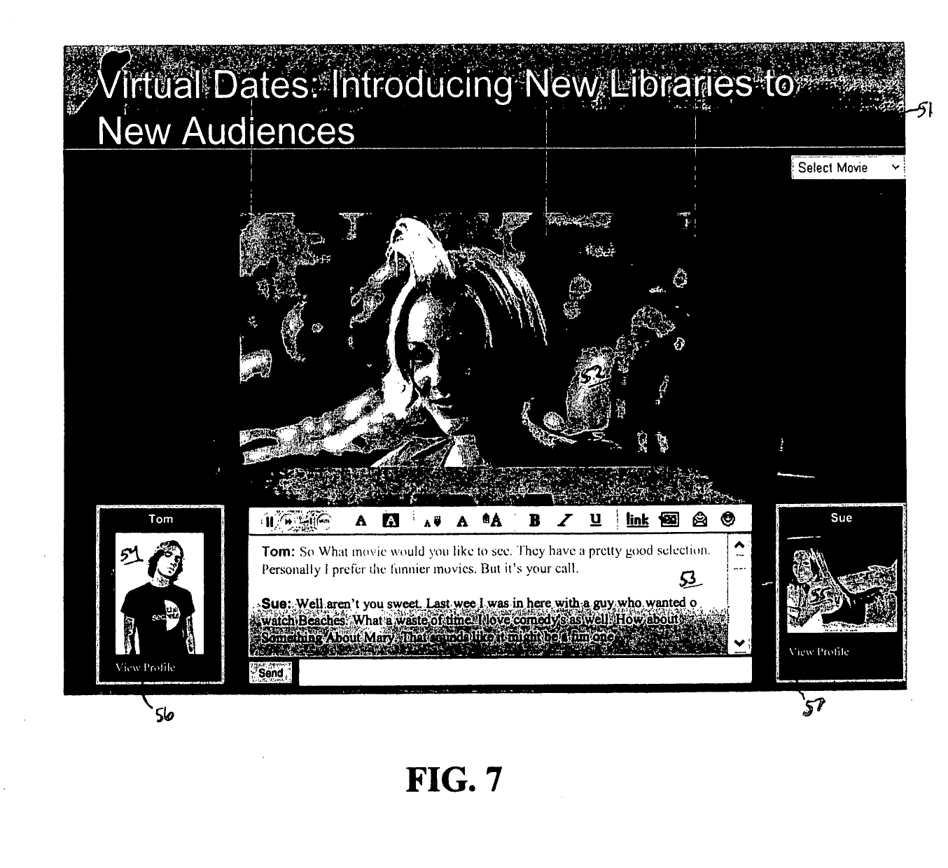

Server 12 hosts the video/chat session. When the video/chat session begins, server 12 generates a user interface (UI). Referring to FIG. 7, the UI 51 may be a chatroom that includes an area 52 for displaying video, and an area 53 for chat. The UI may also include pictures 54, 55 of those who are chatting, along with links 56, 57 for accessing their respective profiles. The example shown in FIG. 7 includes only two people; however, any number of people may be included in the video/chat session. Where screen space is limited for displaying pictures, the pictures may be omitted, or a scroll-bar may be provided to scroll through pictures that are not displayable on-screen at the same time.

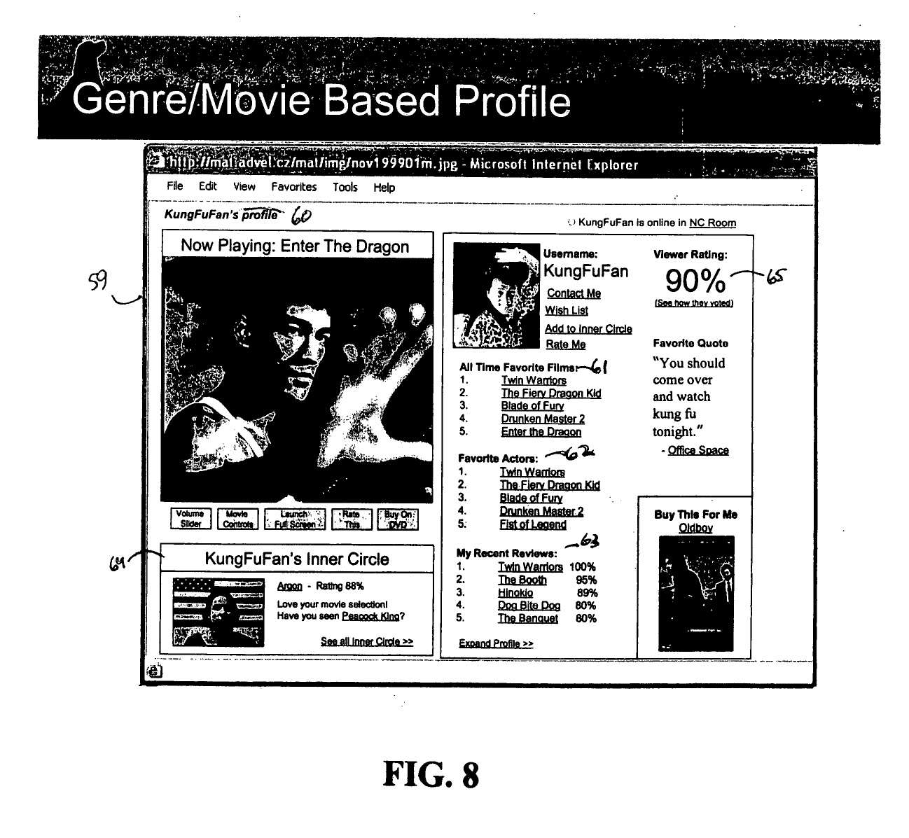

FIG. 8 shows an example of a user profile. In this example, the user's profile includes the username 60, lists of favorite movies 61, actors 62, and recent user reviews 63. Also included is an inner circle list 64, which includes known users, possibly with similar tastes in movies. The viewer rating 65 indicates how others rate the user's video picks.

Chat and video is routed to/from the clients through server 12. This enables server 12 to associate the chat and video, and also to synchronize the video presentation at the clients. More specifically, one aspect of the video/chat system is that the video is displayed at (at least some of) the clients at substantially the same time. This feature enables participants in the chat to have the same frame of reference when discussing the video (via the chat). The video may be synchronized in a number of different ways. Multiple clients may download a video clip prior to a scheduled presentation of the movie, and then server 12 may send a signal to the clients to begin presentation of the video clip at the same time. The video may be DRM-wrapped (where “DRM” stands for “Digital Rights Management”), and downloaded to a hidden directory on each client's computer, which permits only one presentation of the video. Any type of video player may be used to retrieve the video from this directory, and to present the video. Such players include, but are not limited to, Windows® Media Player®, Realplayer®, and Quicktime.

Users who have been invited to participate in a session may be allowed to download the video clip at any time prior to the presentation. For example, a user may view a Web page 44 indicating that video is to be presented in ten days. The user may request to participate in the video/chat and, at any point prior to presentation within that ten days, download the video to the user's computer. Alternatively, several users who are chatting may decide, on the fly, to view a video. That is, users may begin with only the chat portion of the system and then select a video, or may change video during chatting. In these exemplary cases, the users may attempt to download the video at about the same time. In either case, server 12 may request and/or receive an indication from each client when the video has been downloaded. Clients who are waiting for others to complete their download may view a pre-reel, such as movie previews or short clips, which may be downloaded with the video and activated by a command from server 12.

Server 12 may regulate who is permitted to download video based on the capabilities of the client. For example, prior to beginning download, server 12 may perform a test on the network connection of each client. This test is indicative of the time that it will take for each client to download the video, which, in this implementation, may be DVD-quality or HD (high definition) video. If a particular client's connection is poor (e.g., a slow dial-up connection) or computer is slow, that client may not be permitted to download the video or may be required to start the download in advance (e.g., a day or hours before presentation). The reason for this is that other participants, e.g., participants with high-speed connections, should not be forced to wait on the slowest client.

Clients who are not permitted/able to download the video in time may still be allowed to participate in the chat regarding the video even though they may not be able to view the video. Alternatively, server 12 may provide users with lower-speed connections and/or slower computers with a degraded version of the video. For example, server 12 may provide such users with only keyframes of the video, resulting in a slide-show-like presentation at their clients, but still allowing them to participate in the video/chat. Such presentations may be synchronized to other clients to the extent possible. For connections that are fast, but not quite fast enough to satisfy server 12, such as a slow DSL connection, server 12 may provide those clients with video that is lower than DVD-quality, but of better quality than the video provided for dial-up users. The owner of server 12 may configure server 12 to determine a minimum network connection speed and/or computer capabilities required for each type of video (e.g., DVD-quality, HD, standard NTSC, degraded, etc.). Alternatively, the initiator may set the minimum network connection speed and/or computer capabilities in server 12.

Once the video has been downloaded to each client, server 12 may control its presentation. For example, server 12 may send a signal to the clients to begin presenting the video. In this regard, server 12 may confirm that a user at each client is ready to view the video before starting presentation. In one implementation, server 12 may send a signal to each client (or user at the client) asking whether the user is ready to view the video. Server 12 may wait a predetermined time for response to the signal, after which server 12 may deem a non-responding client to be a non-participant in the video/chat. For all those who have indicated that they intend to participate, e.g., those who have responded in time, server 12 may send the appropriate signal to the client(s) to start the video. In this implementation, the signal is sent to all participating clients at about the same time, so that display of the video is substantially synchronized on the participating clients.

Instead of downloading an entire video clip prior to presentation, server 12 may progressively download video to the clients, which may then present video that has been downloaded. Progressive download may be used for pre-scheduled video presentations, but also may be used in cases where there is no pre-scheduled video, e.g., if chatters decide to view a video on-the-fly. Processes for synchronizing progressive downloading are similar to processes for synchronizing downloading of an entire video clip in advance of a video presentation, as described above. As above, the video may be DRM-wrapped. A portion thereof may be downloaded to a hidden directory on each client's computer, which permits only one presentation of the video. Also as above, any type of video player may be used to retrieve the video from this directory, and to present the video.

In the case of progressive download, typically, users may attempt to download the video at about the same time. In this case, prior to beginning the presentation, server 12 may request and/or receive an indication from each client when a predefined portion of the video has been downloaded. Clients who are waiting for others to complete their download may view a pre-reel, such as movie previews or short clips, which may be downloaded with the video and activated by a command from server 12.

Server 12 may regulate who is permitted to download video based on the capabilities of the client in the same manner as described above. For example, prior to beginning download, server 12 may perform a test of the network connection of each client. This test is indicative of the time that it will take for each client to download the video (which, in this implementation, may be DVD-quality video) If a particular client's connection is poor (e.g., a slow dial-up connection) or the computer is slow, that client may not be permitted to participate. The client, however, may still be allowed to participate in the chat. Alternatively, servers may provide clients with lower-speed connections and/or slower computers with a degraded version of the video. For example, server 12 may provide only keyframes of the video, resulting in a slide-show-like presentation at such clients, but still allowing them to participate in the video/chat. For connections that are faster, but not quite fast enough to satisfy server 12, such as a slow DSL connection, server 12 may provide those clients with video that is lower than DVD-quality, but of better quality than the video provided for dial-up users. The owner of server 12 may configure it to determine the minimum network connection speed and/or computer capabilities required for each type of video. Alternatively, the initiator may set the minimum network connection speed and/or computer capabilities in server 12.

Once a portion of video has been downloaded to each client, server 12 may control its presentation. For example, server 12 may send a signal to the client(s) to begin presenting the video. In this regard, server 12 may confirm that a user at each client is ready to view the video before starting presentation. As was the case above, server 12 may send a signal to each client or user asking whether the user is ready to view the video. Server 12 may wait a predetermined time for response, after which server 12 may deem a non-responding client to be a non-participant in the video/chat. For all those who have indicated that they intend to participate, server 12 may send the appropriate signal to such clients to start the video. In this implementation, the signal is sent to all participating clients at about the same time, so that display of the video is substantially synchronized on the participating clients.

Since the entire video clip is not downloaded to a client prior to presentation, problems may occur during presentation that prevent the client from obtaining the remainder of the video. For example, a network connection may go down or network traffic may make the speed of the client's network connection different from what it was originally. During progressive downloading, server 12 may monitor network connections periodically or continually, thereby indirectly monitoring a client's ability to perform progressive downloading and, thus, to keep up with other clients. Server 12 may also track the rate at which a client downloads from server 12, again monitoring a client's ability to perform progressive downloading and, thus, to keep up with other clients. If server 12 detects that a client is falling behind other clients in downloading the video, server 12 may react in different ways depending on whether server 12 determines that the amount by which the client is falling behind will affect presentation of the video on the client (e.g., cause the client to be out of synch with the other clients). Server 12 may simply ignore the problem or it may send the client a message indicating that the client can no longer participate in the video, but may continue to participate in the chat. Alternatively, server 12 may permit the client to download a degraded form of the video (e.g., keyframes as above). Server 12 may notify the client and request confirmation that this is acceptable, or it may simply take action without requesting confirmation from the client. In another alternative implementation, server 12 may simply cause the slower client to skip portions of the video so as to maintain synchronism with the remainder of the clients. Again, server 12 may notify the client and request confirmation that this is acceptable, or it may simply take action without requesting confirmation from the client.

Streaming may also be used to send video from server 12 to the clients. The video may be DRM-wrapped, and a portion thereof may be buffered prior to presentation. As above, any type of video player may be used to retrieve the video, and to present the video.

In the case of streaming, typically, users may request the video at about the same time. As above with progressive downloading, server 12 may regulate who is permitted to download video based on the capabilities of the client. For example, prior to beginning streaming, server 12 may perform a test of the network connection of each client. This test is indicative of the time that it will take for each client to download the video (which, in this implementation, may be DVD-quality video) If a particular client's connection is poor (e.g., a slow dial-up connection) or computer is slow, that client may not be permitted to participate. The client, however, may still be allowed to participate in the chat without the corresponding video. Alternatively, servers may provide users with lower-speed connections and/or slower computers with a degraded version of the video (e.g., keyframes). For connections that are faster, but not quite fast enough to satisfy server 12, such as a slow DSL connection, server 12 may provide those clients with video that is lower than DVD-quality, but of better quality than the video provided for dial-up users. The owner of server 12 may configure it to determine the minimum network connection speed and/or computer capabilities required for each type of video. Alternatively, the initiator may set the minimum network connection speed and/or computer capabilities in server 12.

Prior to beginning a presentation, server 12 may request and/or receive an indication from each client indicating when a predefined portion of the video has been buffered. Clients who are waiting for others to complete their download may view a pre-reel, such as movie previews or short clips, which may be downloaded with the video and activated by a command from server 12. Once a portion of video sufficient to begin video presentation has been buffered in each client, server 12 may control its presentation. For example, server 12 may send a signal to the client(s) to begin presenting the video. As above, server 12 may confirm that a user at each client is ready to view the video before starting presentation, and take appropriate action based on each client's response.

As was the case above, during streaming, problems may occur during presentation the prevent a client from obtaining the remainder of the video. For example, a network connection may go down or network traffic may make the speed of the client's network connection different from what it was originally. During streaming, server 12 may monitor network connections periodically or continually, thereby indirectly monitoring a client's ability to perform progressive downloading and, thus, to keep up with other clients. Server 12 may also track the rate at which a client downloads from server 12, again monitoring a client's ability to perform progressive downloading and, thus, to keep up with other clients. If server 12 detects that a client is falling behind other clients in obtaining the video, server 12 may react in different ways depending on whether server 12 determines that the amount by which the client is falling behind will affect presentation of the video on the client (e.g., cause that client to be out of synch with the other clients). Server 12 may simply ignore the problem or it may send the client a message indicating that the client can no longer participate in the video, but may continue to participate in the chat. Alternatively, server 12 may permit the client to download a degraded form of the video (e.g., keyframes). Server 12 may notify the client and request confirmation that this is acceptable, or it may simply take action without requesting confirmation from the client. In another alternative implementation, server 12 may simply cause the slower client to skip portions of the video so as to maintain synchronism with the remainder of the clients. Again, server 12 may notify the client and request confirmation that this is acceptable, or it may simply take action without requesting confirmation from the client.

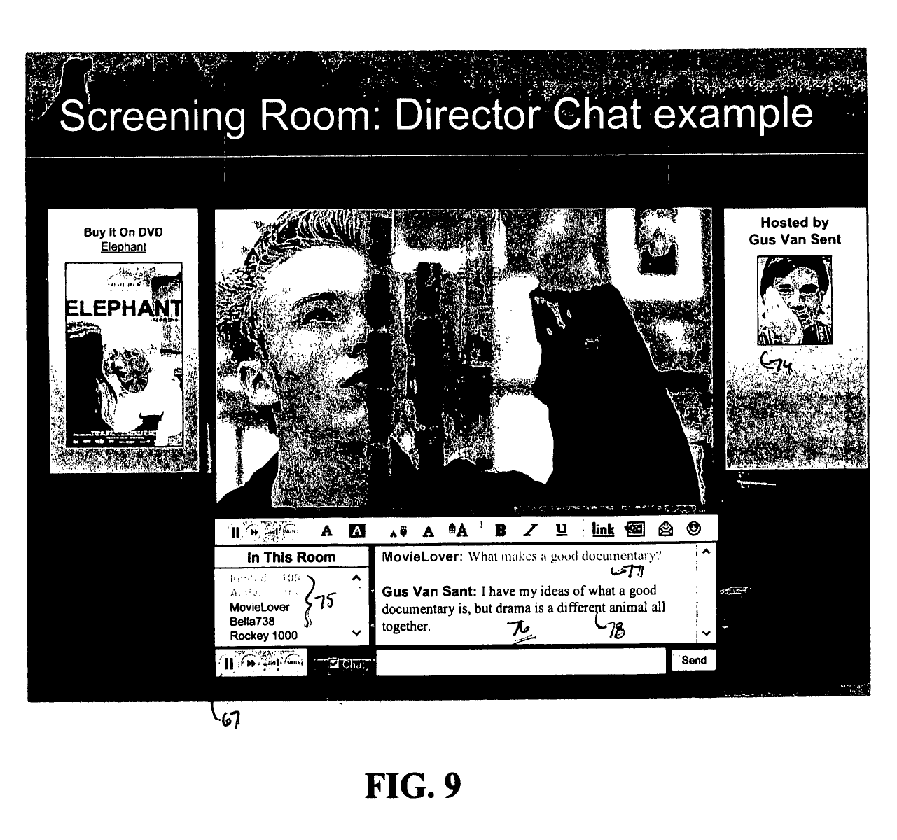

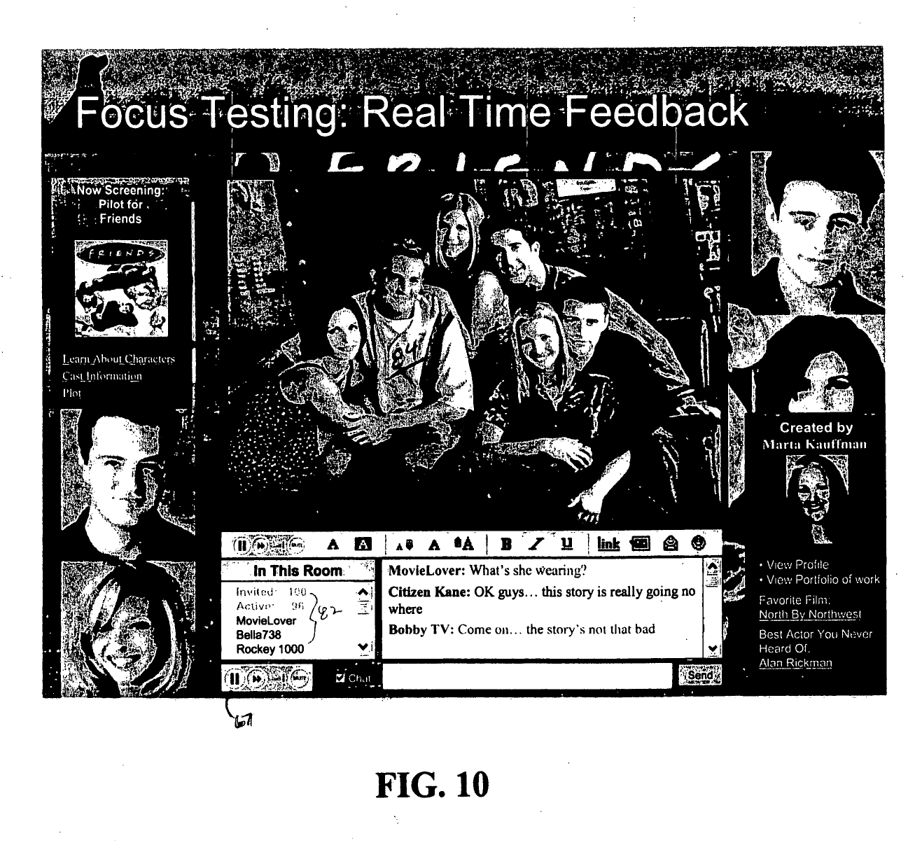

During presentation of the video, synchronization may be maintained in the manner noted above, e.g., by controlling downloading of the video based on a client's capacity and network connection. Users' actions may also affect synchronization of the video among the various clients. In this regard, the UI generated by server 12 may include controls (see controls 67 in FIGS. 9 and 10) that allow a user to affect presentation of the video in real-time. For example, there may be controls to pause, fast-forward, rewind, skip ahead time, frames and/or chapters, and skip back times, frames and/or chapters. All users may have access to these controls or only a subset of users (e.g., one user) may have access to the controls at a time In one implementation, only the initiator may have access to the controls. Access, in this context, means the ability to activate the controls, e.g., by pointing and clicking. Other users may still view the controls even if those other users are not able to affect presentation of the video via the controls.

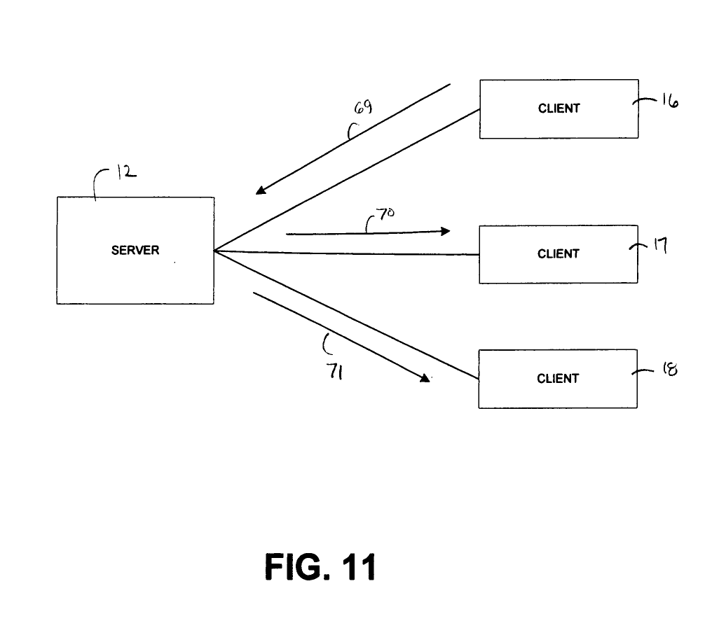

Referring to FIG. 11, when a user activates a control, such as rewind, the corresponding client 16 sends a signal 69 to server 12. The signal indicates the type of action associated with the control—in this example, rewind—and the point (e.g., time, frame or chapter) to which the video is being rewound. Server 12 receives the signal and sends corresponding signals 70, 71 to other clients that are participating in the video presentation. For example, server 12 sends signals 70, 71 to clients 17, 18 indicating that the video is to be rewound and the point (e.g., time, frame or chapter) to which it is to be rewound. Server 12 may pause the video at client 16 to maintain closer synchronization among the clients. The same may occur with respect to other control signals. If, for example, one client is slightly out of synch with the other clients, server 12 may adjust the video on any client (e.g., move it forward or backward) so as to maintain optimal synchronization among the clients. Optimal synchronization, in this example, does not necessarily mean exact synchronization, since network and hardware discrepancies among the clients will likely cause the video on each client to be slightly out of synchronization in most cases.

There are a number of different applications for the video/chat system described herein. For example, the video/chat system may be used to host a virtual date. Referring to FIG. 7, for example, a user 54 may invite an invitee 55 to participate in a video chat session. The invitation may be sent via any of the ways described herein. The invitation may be sent to a person known to user 54, to someone who is met in a chat room, or to a random user of the video/chat system. During the virtual date, user 54 and invitee 55 may view a video in area 52 and chat in area 53. Photographs of both parties may be shown, along with links to their respective profiles. In other implementations, the photographs, links and/or profiles may be omitted.

The video/chat system may be implemented in conjunction with a partner company, such as computer dating services Matchmaker® or Match.com®. For example, a user of a computer dating service may arrange for a virtual date through those services. The proprietor of the video chat system may charge the computer dating service a fee per date, such as US$5.00. The fee may be based on the number of people attending the date, the cost of licensing the movie selected for the date, and/or other factors.

The video/chat system may also be used as a date screening tool. For example, a user may invite any number of dates to a video/chat session, and then eliminate individuals as the video and chat progress. For example, a different individual may be eliminated every ten minutes by the user if the user determines that the individual is not a suitable date. The system may prompt the user to eliminate an individual at predefined time periods or the user may simply eliminate others as desired. In some implementations, the UI may include an animated avatar, which acts as a virtual usher to escort the eliminated individual from the video/chat session. The avatar may be visible to the user or to everyone involved with the session, and may take a form that is selected by the user beforehand. For example, the user may select, e.g., from a predefined list of avatars or a well-known cartoon character, or users can create their own avatar. In this regard, each individual involved in the session may also be represented by an animated avatar, which may be escorted out of the video/chat room by the virtual usher. Alternatively, the avatar may indicate that someone has been eliminated by defacing a picture of that person displayed on the UI.

Private screening is another application for the video/chat system. Referring to FIG. 9, a single individual 74 may respond to questions from participants 75 in the video/chat session. In the example shown in FIG. 9, the individual is a director, the movie being shown is a movie that he directed, and the chat relates to the movie. A moderator, who may be the director or another person (not shown), may receive questions typed by participants, and select which questions to display in chat area 76. Server 12 may assign the role of moderator to one or more clients, which may then filter questions (chat) to present to the person/people responding thereto (e.g., a director). The director may respond to such a question 77, and the response 78 may be displayed in chat area 76, as shown. In this implementation, chat is controlled, and participants do not communicate with each other (they communicate with the director). This, however, need not be the case.

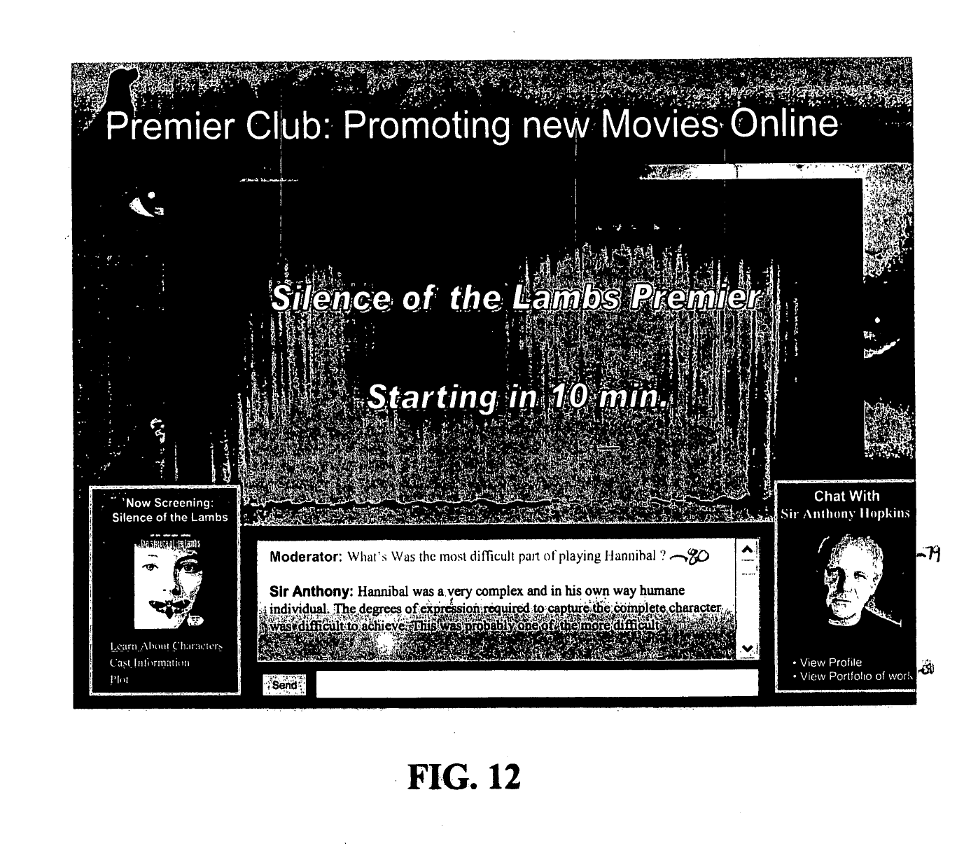

The private screening application may be used to promote new (or old) movies. For example, as shown in FIG. 12, the star 79 of a new movie may chat about the movie. In this example, a moderator 80 is generating/directing the chat. In other implementations, participant chat may be displayed in chat area. As shown in FIG. 12, additional information may be provided, such as a link 81 to the star's portfolio of work.

Participants in the video/chat may be invited (e.g., 100 invitations may be sent out) or participants may join a video/chat already in session. In the latter case, the client communicates with server 12 to obtain the video at the appropriate point in the presentation via any of the foregoing methods, e.g., streaming or progressive downloading.

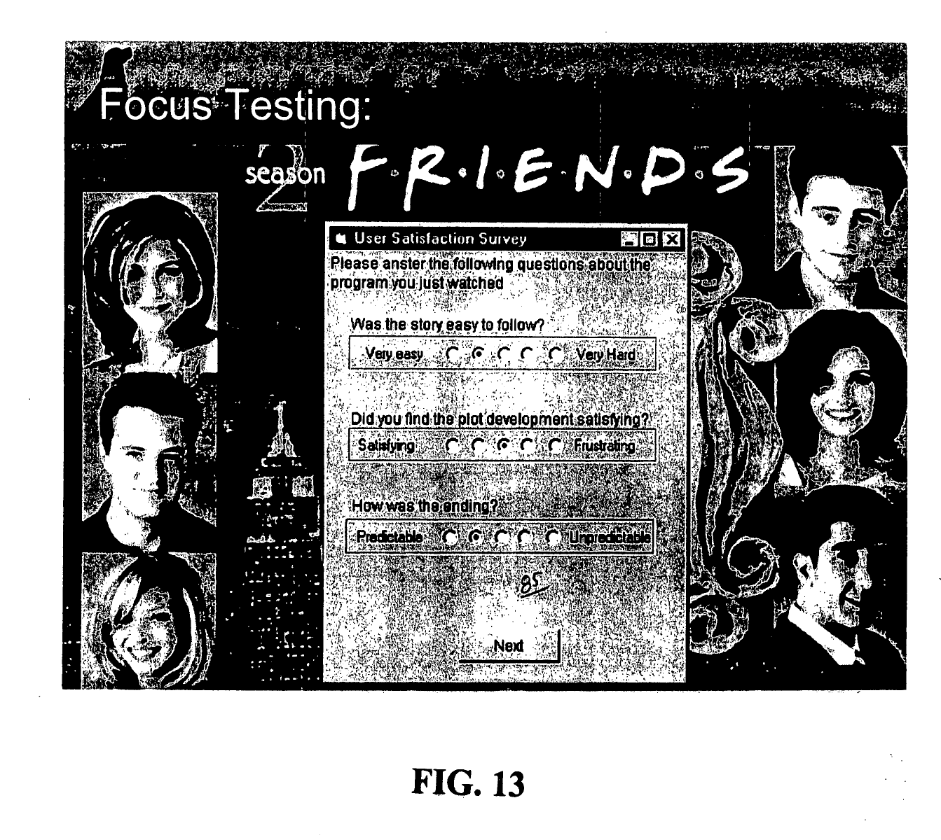

Another application for the video/chat system is focus testing. Focus testing involves participants viewing video, chatting about the video, and, in some cases, answering questions in real-time regarding the video. For example, referring to FIG. 10, participants 82 may comment on the video 84. The comments may be recorded as part of the focus group (the members of which may be invited beforehand). Immediately after the video, or even during the video (e.g., at predefined points), the participants may be asked questions or asked to fill-out a survey form 85 (FIG. 13) containing their comments on the video. At this points, the video may be paused or may continue to run. This information may be transmitted from the clients back to server 12, where it may be collected and analyzed, or simply collected and forwarded to an appropriate third party.

Interactive video may also be displayed through the video/chat system. One example of interactive video is a movie that allows users to select the course of action. That is, at various points in the movie, the user is prompted to decide how the action should proceed. For example, at a point in the movie, a character may be presented with two options, e.g., go through door #1 or go through door #2. The user is prompted to select one or the other options. This action that follows, and the ultimate outcome, depends on the user's selection. For example, if the user selects door #1, a character in the movie may find a treasure, resulting in a happy ending to the movie. Alternatively, if the user selects door #2, the character may be attacked by an animal and killed.

Using the video/chat system described herein, users can collectively determine how the action of a movie will proceed. For example, all users signed onto a video/chat session may be provided with a control (not shown) that allows them to vote each time a character in the movie is presented with two choices. Some portion of the resulting vote, e.g., the majority, may dictate the choice the character makes and, thus, the subsequent action in, and ending of, the movie. This feature may be used in a focus group setting to develop movies. That is, large audiences may view, and vote on, how the action of a movie proceeds. Depending on the result, a filmmaker or studio may decide to release the movie with the action sequence that pleases a majority of people a majority of the time.

In addition to the foregoing features, users may control avatars (examples of which are described above) that interact with the viewing area. For example, the initiator, or each participant, may select/generate an avatar that behaves in accordance with user-input commands. An avatar may be commanded, e.g., to throw tomatoes at the viewing area if the participant dislikes the video. Other actions may also be set. These actions may be user-programmed or predefined by the system.

The video/chat system may also implement a whisper function. The whisper function may be used in the context of a group of participants in the video/chat. For example, a first user may select a second user who is participating in the chat, e.g., by pointing and clicking on the name or icon of the other user. The first user may send, via server 12, a “whisper” invitation to the send user. The invitation may be to participate in a private chat. If the second user accepts, the first and second users may be directed to a private chat area that still enables them to view the video while chatting. Both users may continue to participate in the public chat associated with the video.

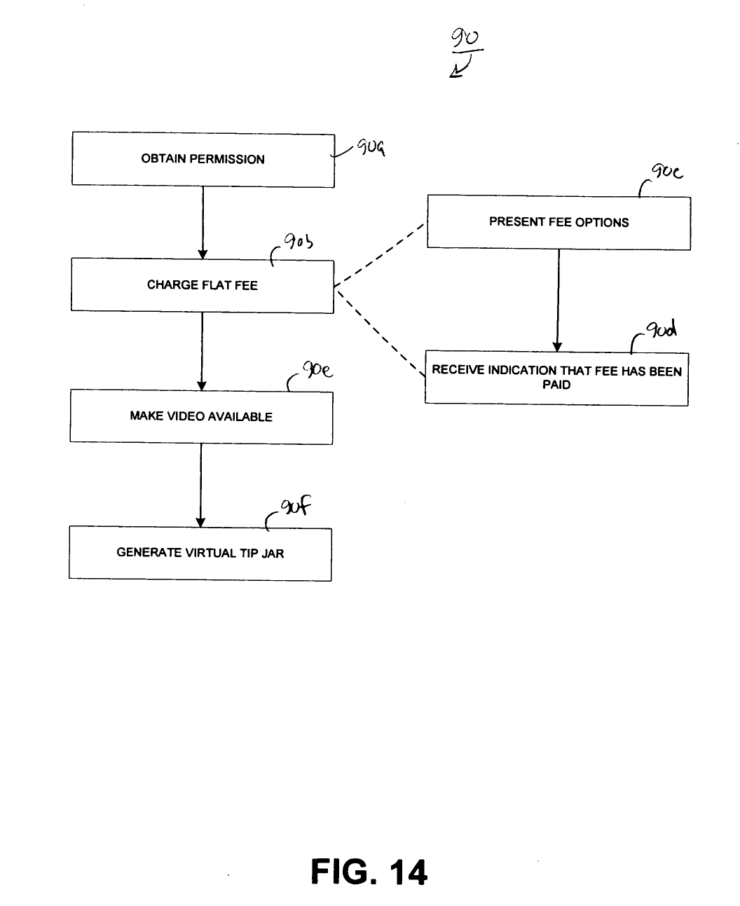

Referring to FIG. 14 (process 90), in order to present video, the proprietor or the video/chat system may be required to obtain permission (90a) to distribute video from an owner of rights in the video. For example, the proprietor may obtain a license from the copyright holder, e.g., a movie studio, or through a license warehousing service. The proprietor may charge (90b) a flat fee for presentation of the video, such as US $5.00. The flat fee may be based on a maximum number of users who are permitted to view the video (along with the cost of licensing the movie selected for the date, and/or other factors). For example, there may be a fee for presenting the video to ten users, a higher fee for presenting the video to twenty users, a still higher fee for presenting the video to fifty users, etc. The amount of the fee does not depend on the number of users who actually view the video, but rather on the maximum number. For example, if a user wants permission to present the video to fifty users, the user must pay the “fifty user” fee regardless of whether ten, twenty or fifty users actually participate in the video presentation. The user may be presented (90c) with different fee options, e.g., on an introductory Web page for setting up a video/chat (see, e.g., Web page 43 of FIG. 5). The different fee options may be based on the maximum number of users who can view the video. The user may select one of the fee options, and pay, e.g., by credit card. Following receipt (90d) of an indication that the fee has been paid, server 12 makes the video available (90e) to the maximum number of users over the one or more computer networks, such as the Internet, as explained above.

Users who pay for the video presentation generally may not charge others who participate in the video/chat. However, the video/chat system may allow such users to present a virtual tip jar to others who are participating in the video/chat. Server 12 may generate (90f) the virtual tip jar, into which users may deposit tips (e.g., via credit card). Because of licensing restrictions, in this implementation the user may not collect more, in the virtual tip jar, than the user was charged to present the video. For example, once full, server 12 may prevent further additions to the tip jar. In other implementations, this need not be the case, and the users may charge others who pay participate in the video/chat an amount that is in excess (or less than) what the user was charged to present the video. For example, a user may run a business as a host for video channels provided by the online video/chat system described herein. Generally speaking, a user running such a business should have the permission of the owner of rights in the content being presented to charge more for the content, although this need not be a requirement.

The processes described herein are not limited to use with any particular hardware, software, or programming language; they may find applicability in any computing or processing environment and with any type of machine that is capable of running machine-readable instructions. All or part of the processes can be implemented in digital electronic circuitry, or in computer hardware, firmware, software, or in combinations thereof. As indicated above, the hardware on the client and/or server side may be part of a desktop or laptop personal computer, a personal digital assistant (PDA), a cellular or other mobile telephone, a personal media player, a portable gaming system, and/or a game console. For game consoles, such as XBox®, and cellular telephones, user interfaces other than Web pages (which are generated by the client application) may be used.

All or part of the processes can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps associated with the processes can be performed by one or more programmable processors executing one or more computer programs to perform the functions of the processes. The method can also be performed by, and the processes can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include a processor for executing instructions and one or more storage area devices for storing instructions and data. Generally, a computer will also include, or be operatively coupled to receive data from, or transfer data to, or both, one or more mass storage devices for storing data, e.g., magnetic, magneto-optical disks, or optical disks. Information carriers suitable for embodying computer program instructions and data include all forms of non-volatile storage area, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks.

All or part of the processes can be implemented in a computing system that includes a back-end component, e.g., as a data server, or that includes a middleware component, e.g., an application server, or that includes a front-end component, e.g., a client computer having a graphical user interface, or any combination of such back-end, middleware, or front-end components. The components of the system can be interconnected by any form or medium of digital data communication, e.g., a communication network. Examples of communication networks include a LAN and a WAN, e.g., the Internet.

Method steps associated with the processes can be rearranged and/or one or more such steps can be omitted to achieve the same, or similar, results to those described herein.

Elements of different Web pages shown herein may be combined to produce fewer Web pages or may be separated to produce additional Web pages for implementing all or part of the functionality described herein. The chat/video session may also be used in conjunction with live events. That is, users may join in video/chat at any portion of a live event and, if available, download the portion of the video that was missed for current or later viewing.

Elements of different embodiments described herein may be combined to form other embodiments not specifically set forth above. Other embodiments not specifically described herein are also within the scope of the following claims.

What is claimed is:

1. A method for use in presenting video over one or more computer networks, the method comprising:
obtaining permission to distribute video from an owner of rights in the video;
charging a flat fee for presentation of the video, the flat fee being based on a maximum number of users who are permitted to view the video; and
following payment of the fee, making the video available to the maximum number of users over the one or more computer networks.

2. The method of claim 1, further comprising:
presenting different fee options, each of the fee options being based on a maximum number of users who are permitted to view the video; and
receiving a selection corresponding to one of the fee options;
wherein the flat fee corresponds to a fee associated with a selected one of the fee options.

3. The method of claim 1, wherein making the video available comprises:
requesting users who are not registered to provide registration information; and
allowing the users to access the video after receipt of the registration information.

4. The method of claim 3, further comprising:
providing an interface on which the users can enter the registration information.

5. The method of claim 1, wherein charging the flat fee comprises:
requesting payment of the flat fee from one of the users, the one of the users being a host user;
receiving an indication that the flat fee has been paid.

6. The method of claim 5, wherein the method further comprises:
generating a virtual tip jar for accepting payment from users other than the host user, the payment not to exceed the flat fee; and
allowing the host user to collect the payment from the virtual tip jar.

7. The method of claim 5, wherein the method further comprises:
generating a virtual tip jar for accepting payment from users other than the host user, where the payment may exceed the flat fee; and
allowing the host user to collect the payment from the virtual tip jar.

8. The method of claim 1, wherein the maximum number of users comprises members of a focus group; and
wherein the method further comprises:
providing the video to the members of the focus group; and
soliciting information from the members of the focus group regarding the video.

9. The method of claim 1, wherein the maximum number of users comprises users who have been designated to preview the video; and
wherein the method further comprises:
providing the video to the users who have been designated to preview the video; and
soliciting information regarding the video from the users who have been designated to preview the video.

10. The method of claim 1, wherein the flat fee is based on a quality of the video, with higher-quality video demanding a larger flat fee and lower-quality video demanding a lower flat fee.

11. A method of offering video for online viewing, the method comprising:
offering the video at a first fee for a first number of users;
offering the video for a second fee for a second number of users, the second fee being different than the first fee;
receiving an indication of payment of the first fee or the second fee; and
making the video available online to a number of users based on the payment.

12. The method of claim 11, wherein making the video available comprises:
requesting users who are not registered to provide registration information; and
allowing the users to access the video after receipt of the registration information.

13. The method of claim 12, further comprising:
providing an interface on which the users can enter the registration information.

14. The method of claim 11, wherein payment is received from a host user who initiates making the video available.

15. The method of claim 14, wherein the method further comprises:
generating a virtual tip jar for accepting payment from users other than the host user, the payment not to exceed a predefined amount; and
allowing the host user to collect the payment from the virtual tip jar.

16. The method of claim 14, wherein the method further comprises:
generating a virtual tip jar for accepting payment from users other than the host user, where the payment may exceed a predefined amount; and
allowing the host user to collect the payment from the virtual tip jar.

17. The method of claim 1 1, wherein the users to whom the video is made available comprise members of a focus group; and
wherein the method further comprises:
providing the video to the members of the focus group; and
soliciting information from the members of the focus group regarding the video.

18. The method of claim 11, wherein the users to whom the video is made available comprise users who have been designated to preview the video; and
wherein the method further comprises:
providing the video to the users who have been designated to preview the video; and
soliciting information regarding the video from the users who have been designated to preview the video.

19. One or more machine-readable media comprising instructions that are executable to offer video for online viewing, the instructions for causing one or more processing devices to:
offer the video at a first fee for a first number of users;
offer the video for a second fee for a second number of users, the second fee being different than the first fee;
receive an indication of payment of the first fee or the second fee; and
make the video available online to a number of users based on the payment.

20. The one or more machine-readable media of claim 19, wherein making the video available comprises:
requesting users who are not registered to provide registration information; and
allowing the users to access the video after receipt of the registration information.

21. The one or more machine-readable media of claim 20, further comprising instructions that are executable to cause the one or more processing devices to:
provide an interface on which the users can enter the registration information.

22. The one or more machine-readable media of claim 19, wherein payment is received from a host user who initiates making the video available.

23. The one or more machine-readable media of claim 22, further comprising instructions that are executable to cause the one or more processing devices to:
generate a virtual tip jar for accepting payment from users other than the host user, the payment not to exceed a predefined amount; and
allow the host user to collect the payment from the virtual tip jar.

24. The one or more machine-readable media of claim 22, further comprising instructions that are executable to cause the one or more processing devices to:
generate a virtual tip jar for accepting payment from users other than the host user, where the payment may exceed a predefined amount; and
allow the host user to collect the payment from the virtual tip jar.

25. The one or more machine-readable media of claim 19, wherein the users to whom the video is made available comprise members of a focus group; and
wherein the one or more machine-readable media further comprises instructions that are executable to cause the one or more processing devices to:
provide the video to the members of the focus group; and
solicit information from the members of the focus group regarding the video.

26. The one or more machine-readable media of claim 19, wherein the users to whom the video is made available comprise users who have been designated to preview the video; and
wherein the one or more machine-readable media further comprise instructions that are executable to cause the one or more processing devices to:
provide the video to the users who have been designated to preview the video; and
solicit information regarding the video from the users who have been designated to preview the video.
